(19) United States
(12) Patent Application Publication
(10) Pub. No.: US 2008/0065488 A1
(43) Pub. Date: Mar. 13, 2008

(54) APPARATUS AND METHOD FOR PROVIDING A COUPON PROGRAM

(75) Inventors: Norbert Schwagmann, Braunschweig (DE); Michael Eckert, Braunschweig (DE); Andreas Schmidt, Braunschweig (DE)

Correspondence Address: DICKSTEIN SHAPIRO LLP, 1177 AVENUE OF THE AMERICAS 6TH AVENUE, NEW YORK, NY, 10036-2714, US

(73) Assignee: Infineon Technologies AG, Neubiberg (DE)

(21) Appl. No.: 11/854,137

(22) Filed: Sep. 12, 2007

Related U.S. Application Data
(60) Provisional application No. 60/825,347, filed on Sep. 12, 2006.

(51) Int. Cl. G06Q 99/00

(52) U.S. Cl. 705/14

(57) ABSTRACT

A data processing arrangement having a memory device which stores at least one rule specifying at least one coupon and specifying an aim which a user has achieved when the at least one coupon has been allocated to the user, a first communication interface which receives data containing information about the at least one rule, and a second communication interface which receives a request for information about the rule and sends the requested information in response to the request.

### RELATED APPLICATION

This application claims priority to Provisional Patent Application Ser. No. 60/825,347, which was filed Sep. 12, 2006, and is incorporated herein by reference in its entirety.

### TECHNICAL FIELD

Embodiments of the invention relate to a data processing arrangement, a client unit, a user terminal, a method for providing coupon programs and a method for using coupon programs.

### BACKGROUND OF THE INVENTION

Coupon programs involve participants being allocated coupons which the participants can cash in at a station, for example, in order to receive a reward. By way of example, for each purchase above a particular value a shop may allocate a voucher for a purchase. It is desirable to have systems which provide a convenient and efficient way of providing and using coupon programs.

### BRIEF DESCRIPTION OF THE FIGURES

FIG. 1 shows a communication arrangement based on an exemplary embodiment of the invention.

FIG. 2 shows a communication system based on an exemplary embodiment of the invention.

FIG. 3 shows a message flow diagram based on an exemplary embodiment of the invention.

FIG. 4 shows a message flow diagram based on an exemplary embodiment of the invention.

FIG. 5 shows a message flow diagram based on an exemplary embodiment of the invention.

FIG. 6 shows a data processing arrangement based on an exemplary embodiment of the invention.

### DETAILED DESCRIPTION

An electronic voucher system allows a user at a station, for example a cashier system, to prove that he has been at a set of other stations, for example voucher issuing stations or coupon issuing stations, or has performed certain activities at these stations. One example of this is that a user at a parking machine in a multistory car park at a large shopping center needs to prove that he has shopped at three different shops in the shopping center, because in this case he receives a price reduction at the parking machine. When shopping in a shop, for example, the user is allocated a coupon, for example during a payment process. In the case of the electronic voucher system, this coupon is stored in electronic form, for example, on a mobile appliance belonging to the user, for example a mobile radio subscriber appliance or a PDA (Personal Digital Assistant) and is read from the mobile appliance at the station at which the proof is being provided, in this example the parking machine.

This application example can be denoted generally as a voucher program. An example of other voucher programs would be that a user purchasing a cinema ticket from a chain of cinemas receives a coupon and, when the user presents nine coupons, he receives free entry at any cinema in the chain of cinemas. A similar application example which can be attributed generally to the class of voucher programs is that a mobile appliance belonging to a user, for example a mobile radio subscriber appliance, automatically generates an electronic coupon when the user uses the mobile appliance to look at, for example play back, an advertising MMS message (MMS: Multimedia Message Service) in full. With a particular number of such electronic coupons the user then receives a price reduction for shopping in a particular shop, for example.

Another class of application examples for coupon systems can be grouped together under the term “night watchman scenario”. In the night watchman scenario, a night watchman has to follow a particular route. At certain points on the route, there are issuing stations at which electronic coupons are automatically transmitted to a mobile appliance belonging to the night watchman, that is to say are stored in electronic form on the night watchman's mobile appliance. In this way, at the end of his duty, for example, the night watchman can prove to a checking system (corresponding to the cashier system above) that he has followed the route correctly.

In similar fashion to in the night watchman scenario, electronic coupons can be used for competitions (for example for orienteering or for a geocaching event). In addition to the functionality which is used in the night watchman scenario, in this case a relationship is also ascertained, by way of example, between the results for a plurality of participants, for example a ranking.

In line with one exemplary embodiment of the invention, a data processing arrangement is provided having a memory device which is set up to store at least one rule specifying at least one electronic coupon and specifying an aim which a user has achieved when the at least one electronic coupon has been allocated to the user. The data processing arrangement also has a first communication interface which is set up to receive data containing information about the at least one rule, and a second communication interface which is set up to receive a request for information about the rule and to send the requested information in response to the request.

In line with one embodiment of the invention, a client unit is provided having a transmission device which is set up to send a request for information about at least one rule specifying at least one electronic coupon and specifying an aim which a user has achieved when the at least one electronic coupon has been allocated to the user, a first reception device which is set up to receive the requested information, a second reception device which is set up to receive an electronic coupon allocated to the user, and a checking device which is set up to check whether the received electronic coupon matches the at least one specified electronic coupon.

In line with one embodiment of the invention, a user terminal is provided having a memory device which is set up to store a rule specifying an event whose occurrence means that an electronic coupon needs to be allocated to the user of the user terminal, and a coupon allocation device which is set up so that, upon the occurrence of the event, it generates an electronic coupon which is allocated to the user of the user terminal.

In line with another embodiment of the invention, a method for providing coupon programs is provided which includes the following steps: storage of at least one rule specifying at least one electronic coupon and specifying an aim which a user has achieved when the at least one electronic coupon has been allocated to the user, reception of data containing information about the at least one rule, and reception of a request for information about the rule and sending of the requested information in response to the request.

In line with another embodiment of the invention, a method for using coupon programs is provided which has the following steps: sending of a request for information about at least one rule specifying at least one electronic coupon and specifying an aim which a user has achieved when the at least one electronic coupon has been allocated to the user, reception of the requested information, reception of an electronic coupon allocated to the user, and checking of whether the received electronic coupon matches the at least one specified electronic coupon.

As an example, the data processing arrangement implements a server unit which allows information about coupon programs, for example the specifications regarding which coupons need to be collected as part of a coupon program in order to receive a reward (or generally to achieve an aim), to be stored and rendered retrievable by client units.

An organizer of coupon programs can, in line with one exemplary embodiment of the invention, use the data processing arrangement to conveniently publicize the coupon programs, and a user can retrieve information about coupon programs and, by way of example, obtain information about coupon programs in which he might wish to participate.

In line with one exemplary embodiment of the invention, the client unit allows a user to retrieve information about coupon programs from the data processing arrangement and to manage the information. By way of example, the user can use his client unit to ascertain his status within a coupon program, for example the number of electronic coupons he has collected which are valid for the coupon program, to display it and to transmit information about his status (either an intermediate position while he is still actively participating in the coupon program or a final position after the coupon program has ended) to the data processing arrangement and in this way to communicate it to other users who have an interest in it and also to retrieve information about the status of other participants within the coupon program from the data processing arrangement.

By way of example, this allows the organizer of a coupon program to obtain information about participation in the coupon program and the success of the coupon program. If the organizer is not happy with the success of his coupon program then he can use the second communication interface of the data processing arrangement to make changes to his coupon program.

In line with one exemplary embodiment of the invention, the user can also use the client unit to register with the data processing arrangement for use of a coupon program. In this case, he is registered as a participant in the data processing arrangement, for example.

Exemplary embodiments of the invention thus allow a user convenient use of coupon programs, since he can obtain detailed information about coupon programs and can also obtain information about his status within a coupon program. He can therefore easily benefit from the advantages of coupon programs and can use discounted programs, for example.

Exemplary embodiments of the invention provide organizers of coupon programs with the opportunity to market their coupon programs easily and hence to stage effective advertising campaigns. The fact that users can easily obtain information about coupon programs and are informed about a large number of coupon programs means that ultimately more users will participate in coupon programs. The organizers also have the option of obtaining detailed information about the success of their coupon programs.

In addition, a new business model is produced for those providing the architecture, for example the data processing arrangement.

The data processing arrangement together with a user's client unit, which the user can use to retrieve information about coupon programs, or an organizer's client unit, which the organizer can use to store information about coupon programs in the data processing arrangement, can be regarded as a client/server architecture.

Refinements of the invention which are described in connection with the data processing arrangement apply (as far as it makes sense) analogously also to the client unit, the user terminal, the method for providing coupon programs and the method for using coupon programs in line with the above exemplary embodiments of the invention.

By way of example, the rule specifies at least one set of electronic coupons, a number of coupons and an aim which a user has achieved when the number of coupons relating to electronic coupons from the set of electronic coupons has been allocated to the user. In addition, the rule can specify at least one coupon property, and, by way of example, the user has achieved the aim when the number of coupons relating to electronic coupons with the at least one coupon property from the set of electronic coupons has been allocated to the user.

By way of example, the data processing arrangement has a third communication interface which is set up to receive information about how many electronic coupons from the set of electronic coupons have been allocated to the user. The third communication interface may be set up to receive information about which electronic coupons from the set of electronic coupons have been allocated to the user.

In one embodiment, the memory device is set up to store the rule in XML format. By way of example, the second communication interface is set up to send the information about the rule in the form of a document in XML format.

In one embodiment, the rule specifies at least one set of electronic coupons, a number of coupons and an aim which the user has achieved when the number of coupons relating to electronic coupons from the set of electronic coupons has been allocated to the user. The client unit may have an ascertainment device which is set up to ascertain how many of the electronic coupons from the set of electronic coupons have been allocated to a user of the client unit.

The client unit may have a further transmission device which is set up to send the information regarding how many of the electronic coupons from the set of electronic coupons have been allocated to the user of the client unit.

The client unit may also have an ascertainment device which is set up to ascertain which of the electronic coupons from the set of electronic coupons have been allocated to a user of the client unit. The client unit may also have a further transmission device which is set up to send the information regarding which of the electronic coupons from the set of electronic coupons have been allocated to the user of the client unit.

By way of example, the client unit is implemented by means of a mobile electronic appliance. As an example, the client unit is implemented by means of a mobile radio subscriber appliance or a PDA.

By way of example, the user terminal is a mobile electronic appliance, for example a mobile radio subscriber appliance or a PDA.

The event is the reading of an electronic advertising message by the user of the user terminal, for example. By way of example, the advertising message is an advertising SMS message or an advertising MMS message. Accordingly, the coupon allocation device is an SMS client unit or an MMS client unit, for example.

By way of example, the user terminal has a client unit as is described above. The electronic coupon produced is transmitted to the client unit, for example.

Exemplary embodiments of the invention are shown in the figures and are explained in more detail below.

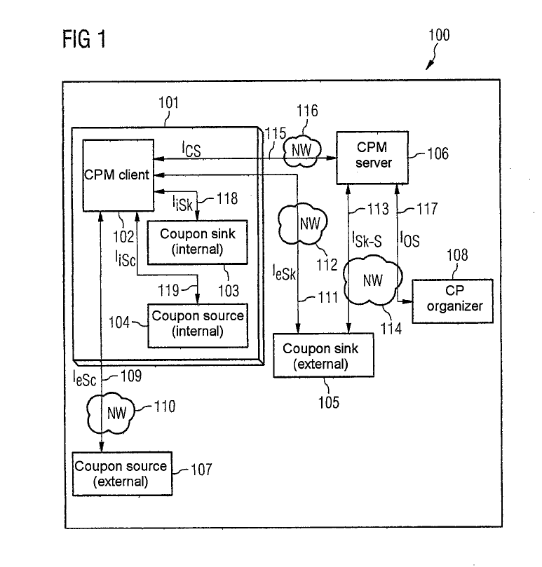

FIG. 1 shows a communication arrangement 100 based on an exemplary embodiment of the invention.

The communication arrangement 100 has an electronic mobile appliance 101 which is used by a user. The mobile appliance is a mobile radio subscriber appliance or a PDA (Personal Digital Assistant), for example. The mobile appliance 101 has a CPM client unit 102, an internal coupon sink 103 and an internal coupon source 104.

The communication arrangement 100 also has an external coupon sink 105, a CPM server unit 106, an external coupon source 107 and an organizer client unit 108, which is implemented by means of a computer system belonging to an organizer of a coupon program, for example.

The external coupon source 107 is coupled to the CPM client unit 102 by means of a first interface 109, which is denoted as I_{eSc}, and by means of a first communication network 110. The external coupon sink 105 is coupled to the CPM client unit by means of a second interface 111, which is denoted as L_{eSk}, and by means of a second communication network 112. The external coupon sink 105 is also coupled to the CPM server unit 106 by means of a third interface 113, which is denoted as I_{Sk-S}, and by means of a third communication network 114. The CPM server unit 106 is for its part coupled to the CPM client unit 102 by means of a fourth interface 115, which is denoted as I_{CS}, and by means of a fourth communication network 116. The organizer client unit 108 is coupled to the CPM server unit 106 by means of the third communication network 114 and by means of a fifth interface 117, which is denoted as I_{OS}.

The interfaces 109, 111, 113, 115, 117 are implemented by means of the respective communication network 110, 112, 114, 116. The communication networks 110, 112, 114, 116 may be different communication networks, including the Internet, for example, mobile radio communication systems, for example in a form based on the UMTS (Universal Mobile Telecommunication Standard) standard or the GSM (Global System for Mobile Communications) standard or local communication networks (for example in the form of a WLAN; WLAN: Wireless Local Area Network).

The internal coupon sink 103 is coupled to the CPM client unit 102 by means of a sixth interface 118, which is an internal interface in the mobile appliance 101 and which is denoted as I_{iSk}. The internal coupon source is likewise coupled to the CPM client unit 102 by means of an internal seventh interface 119, which is denoted as I_{iSc}.

The communication arrangement 100 implements an electronic coupon system based on a client-server architecture, which allows a large number of functionalities as part of the coupon programs. Examples of functionalities of the communication arrangement 100 are explained below.

The fifth interface 117 can be used by an organizer of a coupon program to create and store, retrieve, change and delete the definition of a coupon program on the CPM server unit 106. By way of example, the definition of a coupon program could contain the rule that when a user has received three coupons at a supermarket in a supermarket chain he receives a five euro discount when shopping at a supermarket in the supermarket chain. In addition, the definition of the coupon program could have the rule that a user receives a coupon when he spends thirty euros or more at a supermarket in the supermarket chain. The CPM server unit 106 is thus used to store, manage and render retrievable the definitions of various coupon programs from various coupon program organizers in the form of one or more rules.

The user of the mobile appliance 101 can use the CPM client unit 102 and the fourth interface 115 to obtain information about current coupon programs from the CPM server unit 106, that is to say to request definitions of coupon programs which are stored on the CPM server unit 106. By way of example, the user can use his CPM client unit 102 to display all current coupon programs or else to inquire about particular coupon programs which comply with particular search parameters. Results from such a request for coupon programs to the CPM server unit 106 can be displayed to the user of the mobile appliance 101 using a display on the mobile appliance 101, for example. The CPM client unit 102 provides the user with this and other functionalities as part of the use of coupon programs, in other words as part of the coupon program management (CPM).

By way of example, the user can manage coupon programs in which he is interested using the CPM client unit 102 on the mobile appliance 101. As an example, the CPM client unit can store the definitions of coupon programs which have been transmitted to the CPM client unit 102 as part of a request to the CPM server unit 106 and can manage them for the user. By way of example, it is also possible to store a selection of the definitions of coupon programs which have been transmitted to the CPM client unit 102 as part of a request to the CPM server unit 106 using the CPM client unit 102. In this manner, the user can display the definitions of the coupon programs at a later time and can also delete the definitions of individual coupon programs which have been stored in the mobile appliance 101 using the CPM client unit 102.

The CPM client unit 102 can be used by the user to select, in other words activate, a coupon program whose definition is stored in the CPM server unit 106, that is to say which is managed and provided by the CPM server unit 106. The activation of a coupon program is signaled to the CPM server unit 106 by means of the fourth interface 115. The CPM server unit 106 stores the information regarding which coupon programs are active for the user, that is to say have been activated and have not been deactivated (for example by the user or by the end of the coupon program).

The CPM client unit 102 receives coupons as part of a coupon program on the occasion of particular events in line with the definition of the coupon program. Depending on the embodiment of the coupon program, these events may differ. By way of example, one such event is that the user shops at a particular shop, reads an advertising MMS message fully or lingers close to a particular location. The CPM client unit 102 can receive coupons from the internal coupon source 104 by means of the seventh interface 119 (for example in the case in which the user reads an advertising MMS message fully) or else by means of the first interface 109 from the external coupon source 107 (for example a coupon issuing station on the route which a night watchman must follow).

There may be a large number of external coupon sources 107 and internal coupon sources 104. As mentioned, the internal coupon source 104 is an MMS client unit for the mobile appliance 101, for example, which supports the coupon functionality and allocates an electronic coupon to the CPM client unit 102 when the user reads an advertising MMS message fully.

The CPM client unit 102 can be used by the user to display how many coupons he has already collected as part of the various coupon programs in which he is participating, that is to say which coupons he has already received or else how many or which coupons he still requires in order to receive a particular reward as part of a coupon program (for example a shopping price reduction).

The user is not only able to display to himself his status within the coupon programs in which the user is participating but can also use the CPM client unit 102 to send it to the CPM server unit 106. The CPM server unit 106 can publish the user's status within a coupon program, for example using a web page. An example of one possible instance of application is that the user is participating in a sports event and a coupon corresponds to arrival at a particular destination as part of the sports event, for example passing a particular route post. A user's status within a coupon program may be either a status of the user, while the coupon program is still running, or else a final status, for example the number of coupons which the user has collected as part of the coupon program up to the end of the coupon program.

When the user has successfully participated in a coupon program, that is to say has collected a particular number of coupons or coupons of a particular type, so that he receives a particular reward in line with the definition of the coupon program, he can redeem the coupons at a coupon sink, in this case at the internal coupon sink 103 or the external coupon sink 105. The external coupon sink 105 is arranged outside of the mobile terminal 101 and, by way of example, is a cashier system, for example a parking machine, at which the user can redeem coupons, so that he can park free of charge. Coupons are redeemed at the external coupon sink using the second interface 111.

The sixth interface 118 can be used by the user to redeem coupons at the internal coupon sink 103 using the CPM client unit 102. By way of example, an internal coupon sink 103 is an application which allows electronic payment on the Internet and which can book a credit. By way of example, the user is accredited a credit of ten euros upon redeeming ten coupons, and he can use said ten euros to pay when ordering from an online mail order company.

By way of example, the external coupon sink 105 can use the third interface to check with the CPM server unit 106 whether coupons which the user wishes to redeem at the external coupon sink 105 using the CPM client unit 102 are sufficient for the user to receive a reward. In addition, the external coupon sink 105 can use the third interface 113 to inform the CPM server unit 106 that the user has redeemed coupons at the external coupon sink 105.

Using the third interface, the external coupon sink 105 can also request from the CPM server unit 106 a definition of a coupon program as part of which a user wishes to redeem a coupon. To this end, the external coupon sink 105 indicates the identification of the coupon, for example, which the user wishes to redeem. In addition, the external coupon sink 105 can inform the CPM server unit 106 about the redemption. The third interface may be implemented using the protocols Ethernet, IP, TCP and HTTP for example.

By means of the fifth interface 117, the organizer of a coupon program can use the organizer client unit 108 to obtain information from the CPM server unit 106 regarding how many users are participating in its coupon program and what the status of a participating user is within the coupon program. By way of example, it can view statistics and timings, with which the organizer is provided in the form of a web page (possibly with password protection), for example, and can analyze these and take the analysis as a basis for deciding whether it wishes to change the definitions of a coupon program or to terminate a coupon program.

The organizer client unit 108 may also itself be in the form of a CPM client unit 102. That is to say that the CPM client unit 102 itself allows the definition of a coupon program and that the CPM client unit 102 can be used to store and manage (that is to say alter, delete etc.) the definition of the coupon program on the CPM server unit 106. In this case, the fourth interface 115 would correspond to the fifth interface 117.

For the application scenario of a coupon program where an order for the participants in the coupon program is significant, for example when a coupon corresponds to arrival of a particular destination as part of a sports competition, the user of the mobile appliance 101 can use the CPM client unit 102 to obtain information from the CPM server unit 106 about the status of the other participants in a coupon program in which the user is participating. It is likewise possible for the user, if he has appropriate authorization, to obtain information regarding the coupon programs in which particular users are participating, or regarding which users are participating in a particular coupon program.

As mentioned above, the external interfaces 109, 111, 113, 115, 117 can be implemented using various communication techniques and communication systems. Examples of these are:
Internet, for example using the TCP (Transmission Control Protocol), the HTTP (Hyper Text Transfer Protocol) or using HTML (Hyper Text Markup Language)
intranet
mobile radio communication systems (UMTS, GSM)
WLAN
WiMAX (World Wide Interoperability for Microwave Access)
Bluetooth
IrDa (Infrared Data Association)
USB (Universal Serial Bus) or Wireless USB.

Since, depending on the scenario of application, a coupon may represent a monetary value, it is important for the genuineness of coupons to be able to be assured and checked. By way of example, a coupon sink 103, 105 is supposed to grant a price reduction to the user of the mobile appliance 101 only if the coupon sink 103, 105 can ascertain that the coupons which the user wishes to redeem actually originate from reliable and, by way of example, authorized coupon sources 104, 107 and are not forged, for example. Accordingly the internal coupon source 104 needs to be able to be trusted, in other words it must be a “Trusted Platform”.

It is also important for the CPM client unit 102 itself that the coupons which are received by the CPM client unit 102 are not forged, since it would be disconcerting for the user of the mobile appliance 101 if he were to discover that the coupons are not genuine only upon attempting to redeem coupons at a coupon sink 103, 105. In this case, the user might be very disappointed and the coupon system would appear to be presumably implausible to the user. To ensure that coupons are genuine, it is possible to use conventional methods, for example, such as coupon signatures or source authorization.

The definition of a coupon program may be stored in the form of an XML (Extended Markup Language) document in the CPM server unit 106 and may also be transmitted in this form from the organizer client unit 108 to the CPM server unit 106 and transmitted from the CPM server unit 106 to the CPM client unit 102.

The coupon program definition is used to stipulate various properties or forms of prescribed properties. The following properties may be stipulated in a definition of a coupon program, for example:

Coupon program identification (CP ID): an explicit identification for the coupon program which is allocated by the CPM server unit 106, for example.

Name: a short name for the coupon program which the user is able to understand and which broadly reflects the properties of the coupon program, for example.

Description: a description, for example a detailed description, of the coupon program from which a user can see what requirements and what rewards the coupon program has.

Coupon program type or coupon program class (CP type/class): a class which is associated with the coupon program and which, by way of example, makes it easy for a user to search for coupon programs which are suitable for him. The classification of the coupon programs may be organized hierarchically, for example; examples of this would accordingly be the classes “Sport”, “Sport/hiking”, “Sport/walking”, “Sport/competition”, “Voucher program”, “Voucher program/fast food” etc.

Organizer of the coupon program: a name for the organizer of the coupon program, for example the name of a fast food chain or a supermarket chain.

Organizer classes: a classification for the organizers of coupon programs, for example “fast food chain”, “supermarket chain” etc.

Coupon precepts (possibly in the form of an organized list): this is a list of coupons which a user needs to collect in order to receive a reward as part of the coupon program or in order to successfully complete the coupon program, where the user receives a reward upon successful completion of the coupon program. A coupon program may include a plurality of rewards, and a separate list of coupons which the user needs to collect in order to receive the reward may be defined for each of the rewards. Depending on the application scenario, the coupons need to be collected in a particular order (for example in the case of a sports event), and accordingly an order may be defined for a list of coupons. Coupons in a list of coupons may also be a different type (various coupon types are explained further below).

Coupon program user restrictions: these specify which users are permitted to participate in the coupon program. By way of example, a coupon program is openly provided for all users or else is provided only for certain users (for example only members of particular associations are permitted to participate in a coupon program as part of a sports event).

Participation costs: these can specify costs with which participation in a coupon program is associated. By way of example, participation in a coupon program as part of a sports event may incur a cost.

Region: this statement may specify a particular geographical area or a town where the coupon program can be implemented, that is to say where coupons can be collected as part of the coupon program, for example. By way of example, only coupons from shops which are in a shopping center with an associated multistory car park are valid for a price reduction at a parking machine in the multistory car park.

Level of difficulty: this makes it possible to specify, for example in the case of sports-orientated coupon programs, how difficult it is for a user to complete the coupon program successfully, possible statements for level of difficulty being “beginner”, “advanced”, “expert”, for example.

Collection period: this makes it possible to specify a period in which it is possible to collect coupons as part of a coupon program. By way of example, a fast food restaurant may restrict the collection of coupons as part of a voucher program to two weeks.

Coupon accessibility: this makes it possible to specify, by way of example, whether the period of accessibility and/or the area of accessibility for collecting coupons is restricted. By way of example, a geocaching event may permit coupons to be collected only during daylight, or a voucher program may allow vouchers to be collected only at particular opening times, or coupons may be collected only inside a building (indoors) or not inside a building (outdoors).

Redemption period: this makes it possible to specify the period in which coupons can be redeemed as part of the coupon program. By way of example, a voucher program for a fast food chain may allow coupons to be redeemed only on particular days.

Awards: this makes it possible to specify more precisely what rewards are provided. By way of example, a statement for one reward might say that when three of five prescribed coupons are redeemed, a five euro price reduction is granted, and the statement for another reward might say that when all five of five prescribed coupons are redeemed, a 10.00 euro price reduction is granted. In the case of a sports competition, for example, a reward may merely involve the user having reached a particular number of points or it being established that he has reached a particular destination (for example a particular stage destination).

Approximate time required: this makes it possible to specify approximately how long it will take a user to successfully fulfill a coupon program, that is to say to fulfill the requirements for a reward as part of a coupon program. This may be appropriate for sports events, for example.

Required means of transport or else restrictions regarding means of transport: by way of example, this makes it possible to specify that the coupon program is suitable for pedestrians, that a car is required to successfully participate in the coupon program or that a coupon program is suitable for wheelchair users.

Coupon program dynamics: this makes it possible to specify whether the current definition of the coupon program is permanent or whether the definition may change from participant to participant, may change over the course of time or, when a user has notified the CPM server unit 106 of his status within the coupon program, the coupon program may be customized by the CPM server unit 106 and this may be signaled to the CPM client unit 102.

Coupon authentication information: this makes it possible to specify information regarding the authentication of coupons, for example this makes it possible to specify a public key for an encryption method which (key) may be used for authenticating coupons.

A coupon may also be stored in the form of an XML document which contains information about the coupon. Alternatively, a coupon may merely include an identification for the coupon (for example a coupon identification key in the form of a bit sequence). The following properties may be exhibited by a coupon and may be specified in the coupon (for example in XML):

Coupon type: various types of coupons may be provided, for example
“Location” type: a coupon of this type is used to be able to prove that the user has been at particular locations (for example in the application instance of a night watchman's route described above);
“Cash spending” type: a coupon of this type may be used as evidence that the user has spent money, for example has made a purchase with a particular minimum purchase value;
“Advertising MMS Reading” type: a coupon of this type may be used as evidence that a user has viewed an advertising MMS message fully.

Value: depending on coupon type, this may be used to specify a value for the coupon, for example a cash value or else, in the case of a coupon of the “Location” type, a location statement.

Time stamp: this indicates when the coupon was collected, that is to say was transmitted to the CPM client unit 102 or was allocated to the user.

Coupon source identification (coupon source ID): this is an explicit identification for the coupon source 104, 107 which allocated the coupon.

Coupon authentication information: depending on the authentication mechanism used, this makes it possible to specify certain information, for example a public key which can be used to authenticate the coupon.

The definition of a coupon precept may also be provided on the basis of XML and, by way of example, may be in the form of part of the XML document which contains the definition of the relevant coupon program. As mentioned, the definition of the coupon precept specifies the rules according to which a coupon is accepted or rejected as part of the relevant coupon program. In other words, the definition of the coupon precept specifies properties which a collected coupon needs to have in order to be valid for the coupon program. The definition of the coupon precept may have a similar structure to the definition of a coupon. However, a coupon precept may have specified value ranges specifying in what range the value of a collected coupon needs to be in order to be valid for the relevant coupon program. By way of example, the definition of a coupon precept may contain the following statements:

Coupon type: statement of the type of coupons which are valid for the coupon program.

Value range or value list: depending on the coupon type, this makes it possible to specify a value range or a list of values. The value of a coupon needs to be in the indicated value range or needs to appear in the list of values so that the coupon is valid for the coupon program.

Time stamp range: this makes it possible to specify a time range in which the time stamp for a coupon needs to be in order to be valid.

Coupon source identification range or coupon source identification list: in similar fashion to the value range or the value list, demands are made here on the coupon source identification of the coupon.

Coupon authentication information: this makes it possible to provide a piece of information allowing authentication of coupons, for example a key in an encryption method.

As mentioned, the organizer of a coupon program can use the organizer client unit 108 and the fifth interface 117 to define coupon programs on the CPM server unit 106 and to publish coupon programs. The organizer's access to the CPM server unit 106 using the fifth interface 117 can be implemented using a web browser, that is to say using the description language HTML and using the protocols Ethernet, IP (Internet Protocol), TCP, HTTP, for example.

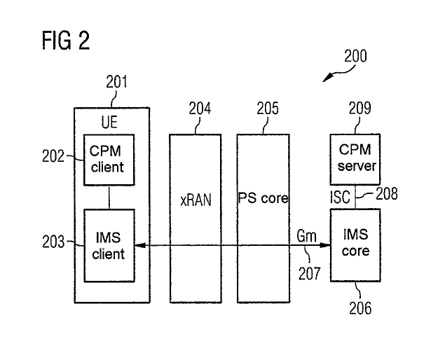

As mentioned, the fourth interface 115 is used for the communication between the CPM client unit 102 and the CPM server unit 106. By way of example, this interface can be implemented using the IMS (IP Multimedia Subsystem) of a mobile radio communication system. This is shown in FIG. 2.

FIG. 2 shows a communication system 200 based on an exemplary embodiment of the invention.

In this exemplary embodiment, the mobile terminal 101 is a mobile radio subscriber appliance 201. The mobile radio subscriber appliance 201 is used for the purpose of using a mobile radio communication system, in this example a mobile radio communication system based on the UMTS standard. Accordingly, the mobile radio subscriber appliance is denoted as UE (User Equipment).

The mobile radio subscriber appliance has a CPM client unit 202 which is arranged and configured as with reference to FIG. 1.

The mobile radio subscriber appliance 201 also has an IMS client unit 203. The communication system 200 has a radio access network (RAN) 204 and a PS (Packet Switched) core network 205. The communication system 200 also has an IMS core network 206 which, together with the PS core network 205, allows use of packet-switched communication services. Using the IMS client unit 203, the radio access network 204 and the PS core network 205, the CPM client unit 203 can use an interface 207 to communicate with the IMS core network 206. A further interface 208 is used by a CPM server unit 209, which is arranged and configured in similar fashion to the CPM server unit 106 in FIG. 1, to communicate with the IMS core network 206. In this way, the fourth interface 115 is implemented between the CPM client unit 102, 202 and the CPM server unit 106, 209.

The signaling protocol used for the IMS is the SIP (Session Initiation Protocol) protocol, which in this exemplary embodiment is also used for tasks as part of coupon programs. In this exemplary embodiment, the IMS core network 206 is part of a UMTS mobile radio communication system, in line with the embodiment of the mobile radio subscriber appliance 201 as a UMTS mobile radio subscriber appliance. In other exemplary embodiments, the IMS core network 206 is part of a GSM mobile radio communication system.

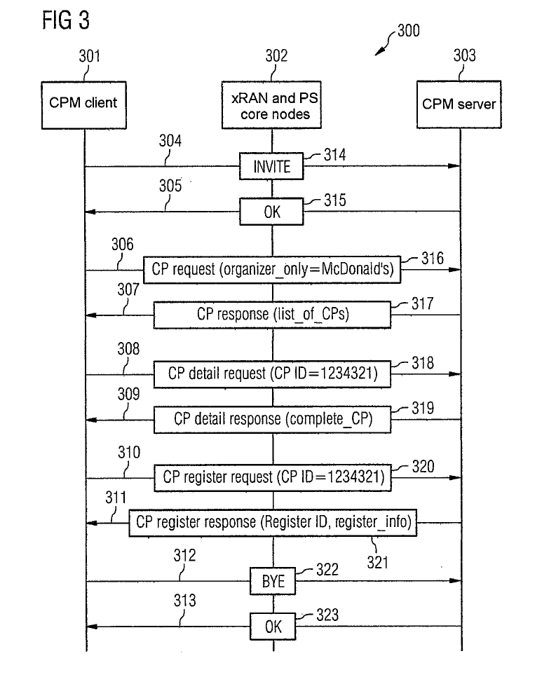

A flow of messages between the CPM client unit 102, 201 and the CPM server unit 106, 209 is explained below with reference to FIG. 3.

FIG. 3 shows a message flow diagram 300 based on an exemplary embodiment of the invention.

The flow of messages shown takes place between a CPM client unit 301, which corresponds to the CPM client unit 202 in FIG. 2, a CPM server unit 303, which corresponds to the CPM server unit 209 in FIG. 2, and interposed network units 302, that is to say units in the radio access network 204, in the PS core network 205 and in the IMS core network 206.

It is assumed that the user of the CPM client unit 301 wishes to obtain information about available coupon programs from the CPM server unit 303.

Messages are transmitted from the CPM client unit 301 to the CPM server unit 303 and messages are transmitted from the CPM server unit 303 to the CPM client unit 301 via the interposed network units 302.

In step 304, the CPM client unit 301 initiates setup of an SIP communication session between the CPM client unit 301 and the CPM server unit 303 by transmitting a first message 314, which is in the form of an SIP INVITE, to the CPM server unit 303.

In step 305, the CPM server unit 303 confirms setup of the SIP communication session by transmitting a second message 315, which is in the form of SIP OK, to the CPM client unit 301. In step 306, the CPM client unit 301 asks the CPM server unit 303 what coupon programs are currently being offered by McDonalds. This is done by transmitting a third message 316, which in this example is denoted as CP Request message and which uses the code strings “Organizer_Only=McDonalds” to indicate that only those coupon programs whose organizer is McDonalds are supposed to be listed by the CPM server unit 303.

In step 307, the CPM server unit 303 responds to the request by transmitting a list of coupon programs. This is done by transmitting a fourth message 317, which is denoted as CP Response message and which contains a list of coupon programs (List_of_CPs). The list of coupon programs contains only portions of the listed coupon programs, for example only their name or a brief description, so that the CP response message is not too large. The user of the CPM client unit 301 can now browse the list and obtain information regarding whether coupon programs which are of interest to him are being offered.

It is assumed that the user, in browsing the list, has come across a coupon program of interest but desires further information about this coupon program, for example a full description of the coupon program or the full definition of the coupon program. Accordingly, detailed information about this coupon program is requested by the CPM client unit 301 in step 308. This is done by transmitting a fifth message 318, which is denoted as CP Detail Request message and which contains a statement indicating the identification of the coupon program about which the user desires detailed information (CP ID=1234321). The CPM server unit 303 responds to the request in step 309 by transmitting a sixth message 319, which is denoted as CP Detail Response message and which contains the detailed information or, by way of example, the full definition of the coupon program (Complete_CP).

If the user now wishes to participate in the coupon program, the CPM client unit 301 transmits a seventh message 320, which is denoted as CP Register Request message and contains an identification for the coupon program (CP ID=1234321), in step 310. This signals that the CPM client unit 301 (or the user) wishes to register for the coupon program (in other words wishes to activate the coupon program for itself). The CPM server unit 303 can refuse the registration (for example because the user is not permitted to participate in this coupon program on the basis of the coupon program user restrictions in the definition of the coupon program, see above) or accept the registration.

If the CPM server unit 303 accepts the registration then in step 311 it transmits an eighth message 321, which is denoted as CP Register Response message and which may contain further information still, for example a registration identification (Register ID), which allows later reference to the registration, to the CPM client unit 301.

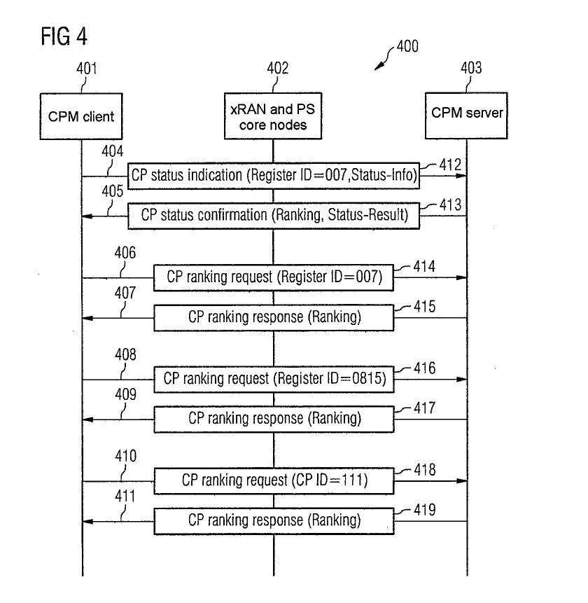

A further flow of messages between the CPM client unit 102, 202 and the CPM server unit 106, 209 is explained below with reference to FIG. 4.

FIG. 4 shows a message flow diagram 400 based on an exemplary embodiment of the invention.

The message flow shown takes place in similar fashion to the message flow shown in FIG. 3 between a CPM client unit 401, a CPM server unit 403 and interposed network units 402.

It is assumed that the user of the CPM client unit 401 wishes to signal his status within a coupon program to the CPM server unit 403 and wishes to request his ranking within the coupon program, that is to say wishes to request at what position in an order of the participants in the coupon program he is currently situated.

In this example, no SIP communication session is set up between the CPM client unit 401 and the CPM server unit 403. In step 404, the CPM client unit 401 sends a first message 412, which is denoted as CP Status Indication message and contains the registration identification (Register ID=007) which has been assigned upon registration for the coupon program. The first message also has the status of the user within the coupon program, for example the identifications for one or more coupons which the user has collected as part of the coupon program.

The CPM server unit 403 responds to the first message 412 in step 405 by means of a second message 413, which is denoted as CP Status Confirmation message and which can contain information regarding the user's status (Status Result) and, by way of example, a statement indicating the current ranking of the user, for example in the case of a sports event.

It is now assumed that the user wishes to request his current ranking after some time, it being assumed that the CPM server unit 403 has already been notified of the end status, that is to say of the user's status within the coupon program when the coupon program is terminated (the user's current ranking can nevertheless change if the coupon program has not yet ended for other participants).

To this end, in step 406 the CPM client unit sends a third message 414 to the CPM server unit 403. The third message 414 is denoted as CP Ranking Request message and contains the registration identification which the user received upon registering for the coupon program (Register ID=007). The requested ranking is signaled to the CPM client unit 401 by the CPM server unit 403 in step 407 in the form of a fourth message, which is denoted as CP Ranking Response message and contains a statement indicating the ranking.

In quite similar fashion, the user can also request the ranking of another user. This is done in similar fashion to steps 406 and 407 in steps 408 and 409 using a fifth message 416 and a sixth message 417. In this case, it is assumed that the registration identification of the other user is 0815 (Register ID=0815).

The user can also request a full order (ranking table) for a coupon program. This is done in steps 410 and 411 using a seventh message 418 and an eighth message 419 in similar fashion to steps 406 and 407, with the difference that instead of a registration identification the seventh message 418 contains a statement indicating a coupon program identification (CP ID=111) which identifies the coupon program for which the order is to be requested.

In one exemplary embodiment, if a user wishes to request the ranking of another user or a full order then the CPM server unit 403 checks whether the user has appropriate rights. If this is not the case then the requests are rejected by means of appropriate messages.

The messages cited with reference to FIGS. 3 and 4 may be implemented in line with SIP MESSAGE, for example, the stated parameters (Register ID, List_of_CPs, the message name etc.) being produced on the basis of XML format in the message body.

As an alternative to implementation of the fourth interface 115 by means of IMS using SIP, the implementation can also be effected using the protocols IP, TCP and HTTP and the IMS and the SIP may not be used.

By way of example, the CPM server unit 106 is operated by the operator of a network, for example a mobile radio network, which can provide the functionalities described in the form of a coupon program management communication service both for the users, for example subscribers in the mobile radio network, and for the organizers of the coupon programs.

As mentioned, the first interface 109 and the second interface 111 may be used by the CPM client unit 102 to receive coupons from the external coupon source 107 and to redeem them at the external coupon sink 105. For the purpose of redemption, the CPM client unit 102 transmits the coupons to be redeemed or else an identification for the relevant coupon program, for example, to the external coupon sink 105. The first interface 109 and the second interface 111 may be implemented by means of Bluetooth, but other communication networks are also suitable for this, as mentioned above.

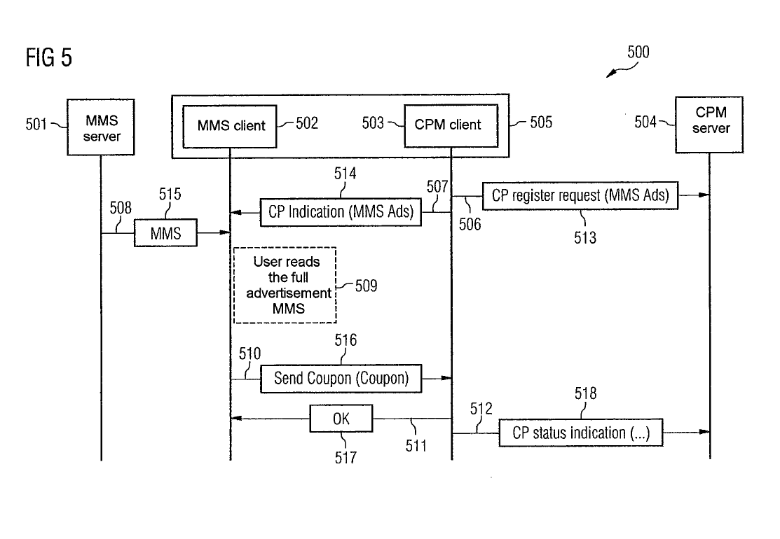

The use of the sixth interface 118 and of the seventh interface 119, which are internal interfaces in the mobile appliance 101, is explained below with reference to FIG. 5.

FIG. 5 shows a message flow diagram 500 based on an exemplary embodiment of the invention.

The message flow shown takes place between an MMS server unit 501, an MMS client unit 502, a CPM client unit 503 and a CPM server unit 504.

In this example, the MMS client unit 502 corresponds to the internal coupon source 104 and, like the CPM client unit 503 and the CPM server unit 504, is arranged and configured as explained with reference to FIG. 1.

Accordingly, the MMS client unit 502 and the CPM client unit 503 are part of a mobile appliance 505, which corresponds to the mobile appliance 101.

It is assumed that the user of the mobile appliance 505 wishes to register for a coupon program denoted as MMS Ads. In the case of this coupon program, the user receives a credit of 1 euro for his mobile radio invoice (it is assumed that the mobile appliance 505 is a mobile radio subscriber appliance) for each advertising MMS message read. To register for the coupon program, the CPM client unit 503 transmits a first message 513, which is denoted as CP Register Request message and contains an identification for the coupon program (MMS Ads), to the CPM server unit 504 in step 506.

In step 507 the CPM client unit 503 informs the MMS client unit 502 about the registration for the coupon program (it has been assumed that the CPM server unit 504 has accepted the registration). This is done by transmitting a second message 514, which is denoted as CP Indication message and contains an identification for the coupon program (MMS Ads). The MMS client unit 502 now has the information that each time the user of the mobile appliance 505 reads an MMS message (complying with the precepts of the coupon program) it transmits an appropriate coupon to the CPM client unit 503.

It is now assumed that in step 508 the MMS server unit 501 uses a mobile radio network, for example, to transmit an MMS message 515 to the MMS client unit 502 and the user of the mobile appliance 505 reads the MMS message 515 fully in step 509 and the MMS message 515 is an advertising MMS message where the user earns a coupon as part of the coupon program when he reads the message fully.

When the MMS client unit 502 has established that the user has read the MMS message fully, it generates an appropriate coupon and sends it in step 510 to the CPM client unit 503 using a third message 516, which is denoted as Send Coupon message and contains the coupon.

In another embodiment, the MMS client unit 502 does not send the coupon itself to the CPM client unit 503 but rather transmits only the information that the user has read the MMS message 515 fully. In this case, the CPM client unit 503 generates an appropriate coupon itself and is therefore itself the internal coupon source 104.

In step 511, the CPM client unit 503 uses a fourth message 517, which is denoted as OK message, to confirm receipt of the coupon, or, in the alternative embodiment, receipt of the information that the user has read the MMS messages 515 fully, to the MMS client unit 502.

In step 512, the CPM client unit 503 sends its status within the coupon program, which has been changed by the newly added coupon, to the CPM server unit 504 using a fifth message 518 (CP Status Indication message).

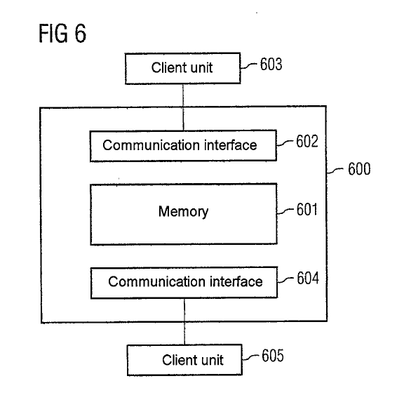

In summary, one embodiment provides a data processing arrangement, as illustrated in FIG. 6.

FIG. 6 shows a data processing arrangement 600 based on an exemplary embodiment of the invention.

The data processing arrangement 600 has a memory 601 for storing at least one rule which specifies at least one electronic coupon and which specifies an aim which a user has achieved when the at least one electronic coupon has been allocated to the user.

The data processing arrangement 600 also has a first communication interface 602 for receiving data containing information about the at least one rule. By way of example, the data are transmitted from a first client unit 603 to the data processing arrangement 600.

In addition, the data processing arrangement has a second communication interface 604 for receiving a request for information about the rule and for sending the requested information in response to the request. By way of example, the request is transmitted from a second client unit 605 to the data processing arrangement 600, and the requested information is transmitted to the second client unit 605.

What is claimed is:

1. A user terminal, comprising:
a memory device configured to store a rule specifying an event whose occurrence indicates that an electronic coupon is to be allocated to a user of the user terminal; and
a coupon allocation device configured to, upon the occurrence of the event, generate an electronic coupon which is allocated to the user of the user terminal.

2. The user terminal as claimed in claim 1, wherein the user terminal is a mobile electronic appliance.

3. The user terminal as claimed in claim 12, wherein the user terminal is a mobile radio subscriber appliance or a PDA.

4. The user terminal as claimed in claim 1, wherein the event is reading of an electronic advertising message by the user of the user terminal.

5. The user terminal as claimed in claim 4, wherein the advertising message is an advertising SMS message or an advertising MMS message.

6. The user terminal as claimed in claim 5, wherein the coupon allocation device is an SMS client unit or an MMS client unit.

7. The user terminal as claimed in claim 1, wherein the event is the user terminal being located close to a particular location.

8. The user terminal as claimed in claim 7, wherein the electronic coupon may be generated only within a perdetermined time period.

9. A user terminal, comprising:
a memory means for storing a rule specifying an event whose occurrence indicates that an electronic coupon is to be allocated to a user of the user terminal; and
a coupon allocation means for, upon the occurrence of the event, generating an electronic coupon which is allocated to the user of the user terminal.

10. A method of operating a user terminal, comprising:
storing a rule specifying an event whose occurrence indicates that an electronic coupon is to be allocated to a user of the user terminal; and
upon the occurrence of the event, generating an electronic coupon which is allocated to the user of the user terminal.

11. The method as claimed in claim 10, further comprising:
publishing a status of the user within a coupon program.

12. The method as claimed in claim 10, wherein the event is reading of an electronic advertising message by the user of the user terminal.

13. The method as claimed in claim 10, wherein the event is the user terminal being located close to a particular location.

14. A communication arrangement comprising:
a server unit configured to provide definitions of various coupon programs in a form of one or more rules; and
a user terminal, comprising:
a receiver configured to receive from the server unit a rule specifying an event whose occurrence indicates that an electronic coupon is to be allocated to a user of the user terminal;
a memory device configured to store the rule; and
a coupon allocation device configured to, upon the occurrence of the event, generate an electronic coupon which is allocated to the user of the user terminal.
